(19) United States
(12) Patent Application Publication
(10) Pub. No.: US 2025/0209403 A1
(43) Pub. Date: Jun. 26, 2025

(54) ARTIFICIAL INTELLIGENCE MODEL FOR CONTROLLING INTERACTION DISPUTE

(71) Applicant: EQUIFAX INC., Atlanta, GA (US)

(72) Inventors: Cuizhen Shen, Duluth, GA (US); Brady Harrison, Boise, ID (US); Arunkumar Ranganathan, Cumming, GA (US); Jenna Acquaviva, Jupiter, FL (US); Anna Rickman, Fullbrooke, CA (US)

(21) Appl. No.: 18/396,230

(22) Filed: Dec. 26, 2023

(51) Int. Cl. G06Q 10/0635; G06F 40/284; G06N 3/0455; G06V 30/10

(52) U.S. Cl. CPC G06Q 10/0635; G06F 40/284; G06N 3/0455; G06V 30/10

(57) ABSTRACT

A system can be used to provide a responsive message for controlling an interaction dispute. The system can receive tokens from an optical character recognition model. The set of tokens can represent at least evidence data relating to an interaction dispute. The system can determine, using an artificial intelligence model, a first likelihood that represents a similarity between a subset of the tokens and the interaction dispute. The system can determine a second likelihood that traversing to the interaction dispute may result in success. The system can provide the responsive message that can control the interaction dispute based on the first likelihood and the second likelihood. The responsive message can include a response to the interaction dispute.

### TECHNICAL FIELD

The present disclosure relates generally to risk assessment and interaction control. More specifically, but not by way of limitation, this disclosure relates to using artificial intelligence techniques to control an interaction dispute by determining whether to respond to a dispute, generating a response to the dispute, and the like.

### BACKGROUND

Various interactions are performed frequently through an interactive computing environment, such as a website, a user interface, etc, in person, and the like. The interactions may involve transferring resources for, or otherwise based on, content or goods that can be provided via the interactive computing environment, in person, or the like. In some cases, a providing entity may receive a dispute regarding a particular interaction, and the dispute may allege that the particular interaction was associated with malicious intent, such as fraud, that the particular interaction was unsuccessful, or the like. The providing entity may be presented with an option to respond to the dispute, but due to an excessive and continuously increasing number of disputes received in modern times, it may be difficult for the providing entity to respond to the dispute or to even determine whether to respond.

### SUMMARY

Various aspects of the present disclosure provide systems and methods for controlling an interaction dispute using artificial intelligence techniques. The system can include a processor and a non-transitory computer-readable medium that can include instructions that are executable by the processor to cause the processor to perform various operations. The system can receive a set of tokens from an optical character recognition model. The set of tokens can represent at least evidence data relating to an interaction dispute. The system can determine, using an artificial intelligence model that may be configured to receive the set of tokens as input, a first likelihood that can represent a similarity between at least a subset of the set of tokens and the interaction dispute. The system can determine, using a machine-learning model, a second likelihood that traversing the interaction dispute may result in success. The system can provide a responsive message that can control the interaction dispute based on the first likelihood and the second likelihood. The responsive message can include a response to the interaction dispute.

In other aspects, a method can be used to control an interaction dispute using artificial intelligence techniques. The method can include receiving, by a computing system, a set of tokens from an optical character recognition model. The set of tokens can represent at least evidence data relating to an interaction dispute. The method can include determining, by the computing system and by using an artificial intelligence model that can be configured to receive the set of tokens as input, a first likelihood that can represent a similarity between at least a subset of the set of tokens and the interaction dispute. The method can include determining, by the computing system and by using a machine-learning model, a second likelihood that traversing the interaction dispute may result in success. The method can include providing, by the computing system, a responsive message that can control the interaction dispute based on the first likelihood and the second likelihood. The responsive message can include a response to the interaction dispute.

In other aspects, a non-transitory computer-readable medium can include instructions that are executable by a processing device for causing the processing device to perform various operations. The operations can include receiving a set of tokens from an optical character recognition model. The set of tokens can represent at least evidence data relating to an interaction dispute. The operations can include determining, using an artificial intelligence model that can be configured to receive the set of tokens as input, a first likelihood that can represent a similarity between at least a subset of the set of tokens and the interaction dispute. The operations can include determining, using a machine-learning model, a second likelihood that traversing the interaction dispute may result in success. The operations can include providing a responsive message that can control the interaction dispute based on the first likelihood and the second likelihood. The responsive message can include a response to the interaction dispute.

This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

The foregoing, together with other features and examples, will become more apparent upon referring to the following specification, claims, and accompanying drawings.

### BRIEF DESCRIPTION OF DRAWINGS

FIG. 1 is a block diagram illustrating an example of a computing environment in which artificial intelligence techniques can be used to control an interaction dispute according to certain aspects of the present disclosure.

FIG. 2 is a flowchart illustrating an example of a process for using artificial intelligence techniques to control an interaction dispute according to certain aspects of the present disclosure.

FIG. 3 is a flowchart illustrating an example of a process for determining a risk assessment indicator using artificial intelligence techniques according to certain aspects of the present disclosure.

FIG. 4 is a block diagram of an example of an architecture of an artificial intelligence model that can be used to control an interaction dispute according to certain aspects of the present disclosure.

FIG. 5 is a block diagram depicting an example of a computing system suitable for implementing aspects of the techniques and technologies presented herein.

### DETAILED DESCRIPTION

Certain aspects described herein for using an artificial intelligence model to control an interaction dispute can address one or more of the foregoing issues. For example, the artificial intelligence model, which may include an optical character recognition model, a natural language processing model, a generative artificial intelligence model, a machine-learning model, other suitable models, or any suitable combination thereof, can be used to identify at least a subset of a set of interaction disputes that may be illegitimate or that may otherwise be associated with malicious intent. Additionally or alternatively, the artificial intelligence model can be used to automatically identify evidence data that can be used to respond to one or more particular interaction disputes, can be used to automatically generate a response to the one or more particular interaction disputes, and the like. In some examples, the response may be or include a letter traversing the one or more particular interaction disputes, or other suitable examples for the response.

An interaction dispute may involve a receiving entity, which may have previously initiated or otherwise engaged in an interaction with a providing entity, initiating a dispute to allege that the interaction was unsuccessful. An unsuccessful interaction may involve content, services, or goods that are defective or not as agreed-upon by the receiving entity and the providing entity, may involve a failure of the providing entity to provide the agreed-upon content, services, or goods, or other pathways of failure for the interaction. In other examples, however, the receiving entity may initiate the interaction dispute with malicious intentions: even though the interaction may have been successful, the receiving entity may initiate the interaction dispute anyway and to recover previously transferred resources without returning the content, services, or goods, which may sometimes involve fraudulent activity. In a particular example, a receiving entity may order and successfully receive a good from the providing entity in exchange for providing resources to the providing entity, but the receiving entity may initiate the interaction dispute to recover the resources without reversing the interaction. The providing entity may receiving an excessive number of interaction disputes over a predetermined amount of time, and it may be difficult for the providing entity to determine whether each interaction dispute is legitimate and whether to traverse each interaction dispute or any subset thereof.

A risk assessment computing system may include the artificial intelligence model, may be communicatively coupled with a separate computing device that includes the artificial intelligence model, or may otherwise be configured to execute the artificial intelligence model. The risk assessment computing system may receive a request to evaluate a risk associated with a particular interaction dispute. For example, a client computing system can receive the interaction dispute and can transmit the interaction dispute, and any data associated therewith, to the risk assessment computing system with a request to perform a risk assessment on the interaction dispute. The risk assessment computing system can receive the interaction dispute and data associated therewith, and the risk assessment computing system can use an optical character recognition model to convert the received data, which may include images, PDF data files, and other non-text input, into text-based data that can be used by the artificial intelligence model. The risk assessment computing system can input the text-based data, which may include the converted text-based data and any additional text-based data associated with the interaction dispute, into the artificial intelligence model.

The artificial intelligence model can receive the text-based data and can use a natural language processing model to identify patterns in the text-based data, to understand intents of the text-based data, or to otherwise suitably evaluate the text-based data. In some examples, the natural language processing model can be used to identify a subset of the text-based data that may be useful for responding to the interaction dispute, for determining whether the interaction dispute is legitimate, or the like. The natural language processing model can generate a first output that can exclude personally identifiable information, protected personal information, or other private data that may be protected from unauthorized disclosure. The first output can be provided to the generative artificial intelligence model, which may be or include a large language model. The generative artificial intelligence model can include an adapter layer that can be used to identify portions of the first output that may be related to useful responses to the interaction dispute. The generative artificial intelligence model can receive the first output from the natural language processing model and can generate a second output that can be provided to the machine-learning model. In some examples, the machine-learning model may be or include a probabilistic model, a computer vision model, or the like. The machine-learning model may receive the second output from the artificial intelligence model and may generate a third output that can indicate whether the evidence data associated with the interaction dispute can be used to successfully traverse the interaction dispute.

The risk assessment computing system can receive historical data that can be used to understand historical patterns, such as successes and failures, of previously dispositioned interaction disputes. For example, the historical data can include historical interaction data about previously executed interactions, can include historical interaction dispute data about entities involved in historical interaction disputes, about content, goods, or services associated with historical interaction disputes, successes and failures associated with historical interaction disputes, and the like. The risk assessment computing system can cluster the historical data or can otherwise suitably analyze the historical data to map inputs, such as interaction dispute data, to outputs such as a success or failure of traversing the historical interaction disputes. In some examples, the risk assessment computing system can use the historical data as input into a model, algorithm, service, or the like that can match historical interaction disputes with historical interaction data, to evaluate the historical interaction disputes and the historical interaction data, and the like.

The risk assessment computing system can use the historical interaction data and the output from the artificial intelligence model to rank-order evidence data associated with the received interaction dispute. For example, the risk assessment computing system may execute a probabilistic model, which in some examples may be or include the machine-learning model included in the artificial intelligence model, to generate a rank-order list that ranks evidence data associated with the received interaction dispute. The rank-order list may identify a first piece of evidence that is most likely to result in a successful traversal of the interaction dispute and present the first piece of evidence more prominently, such as at the top of the rank-order list, larger than other pieces of evidence in the rank-order list, etc., than other pieces of evidence in the rank-order list. Additionally or alternatively, the rank-order list may identify a second piece of evidence that is next-most-likely to result in a successful traversal of the interaction dispute and may present the second piece of evidence more prominently, such as near the top of the rank-order list, larger than other pieces of evidence (except the first piece of evidence) in the rank-order list, etc., than other pieces of evidence, except the first piece of evidence, in the rank-order list, and so on. The risk assessment computing system can use one or more data mining algorithms to generate one or more insights about the rank order list, or any pieces of evidence included therein. In some examples, the insights may provide guidance to the client that requested a risk assessment about the interaction dispute regarding a likelihood that traversing the interaction request may be successful based on the available evidence data.

The risk assessment computing system can use the received evidence data to automatically generate a response to the interaction dispute with the highest probability of success compared to other versions of the response. For example, the risk assessment computing system can use the text-based data as input into the generative artificial intelligence model, which can generate a letter that can be used to respond to the interaction dispute. In other examples, a step-wise prompting technique can be used with respect to the generative artificial intelligence model to generate, or polish, the response to the interaction dispute to optimize a quality of the response, to optimize the likelihood of the traversal against the interaction dispute being successful, or the like.

In some examples, the request for risk assessment may be transmitted via an interactive computing environment. The interactive computing environment can be provided by a client computing system or by the risk assessment computing system. For example, the client computing system can be, or may be controlled by, an entity that may provide software as a service, infrastructure as a service, one or more different types of goods, or other suitable goods or services accessible by a user computing system that can be used or otherwise accessed by a receiving entity. In some examples, the interactive computing environment can include a user interface. The receiving entity can use the user computing system to request access to a particular user interface that can be used to request the interaction, to submit the interaction dispute, or the like. In some examples, the interactive computing environment can include one or more websites or sub-pages thereof. For example, the interactive computing environment can include a secure website provided by the client computing system or the risk assessment computing system. The secure website can include cloud computing storage or other resources, and the client computing system can control access of a target entity to the secure website via suitable security techniques such as multi-factor authentication, username/password combinations, etc. In some examples, the client computing system can access an interactive computing environment provided by the risk assessment computing system to request risk assessment of an interaction dispute submitted by a user computing system.

In some examples, the artificial intelligence techniques can be used for other suitable purposes in addition to, or alternative to, controlling or otherwise facilitating a decision with respect to the interaction dispute. For example, the artificial intelligence techniques can be used to verify an identity of a target entity, to determine whether to provide real-world goods and/or services on behalf of the target entity or other entities, and the like. The artificial intelligence techniques can involve applying one or more risk signals to a linked graph to determine, for example with respect to an online interaction, a reverse interaction, an interaction dispute, or a real-world interaction, a likelihood that the request, or the interaction dispute, submitted by the receiving entity is genuine. In another example, a client, such as a provider of restricted or regulated goods or services, can use the artificial intelligence techniques to determine whether to provide the restricted or regulated goods or services to the receiving entity. In some examples, the artificial intelligence techniques can be generally used for digital enablement of an interaction with respect to the receiving entity and one or more real-world items.

Certain aspects described herein, which can include using an artificial intelligence model and providing a responsive message using output from the artificial intelligence model, can improve at least the technical fields of controlling an interaction dispute, access control for a computing environment, or a combination thereof. For instance, by generating and transmitting the responsive message based on the output from the artificial intelligence model, the risk assessment computing system can cause an interaction dispute to be controlled more accurately. The responsive message may be used to better predict whether the interaction dispute is legitimate and whether traversing the interaction dispute using available evidence may be successful, and using the responsive message may yield fewer malicious interaction disputes, or fewer successful malicious interaction disputes, than if the responsive message is not used. And, transmitting the responsive message facilitates a practical application of the artificial intelligence techniques described herein by facilitating control of a real-world process such as the interaction dispute. Additionally or alternatively, by using the artificial intelligence techniques, a risk assessment computing system may provide legitimate access to the interactive computing environment using fewer computing resources compared to other risk assessment systems or techniques. For example, the artificial intelligence model can determine a risk indicator using less data about the receiving entity than other techniques, which may rely on identifying data such as fingerprints, facial scans, and the like. By using less data, (i) memory usage, (ii) processing time, (iii) network bandwidth usage, (iv) response time, and the like for controlling access to the interactive computing environment is reduced, and functioning of a computing device is improved. Accordingly, the risk assessment computing system improves the access control for computing environment by reducing memory usage, processing time, network bandwidth consumption, response time, and the like with respect to controlling access to the interactive computing environment using at least the artificial intelligence techniques described herein.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative examples but, like the illustrative examples, should not be used to limit the present disclosure.

### Operating Environment Example for Artificial Intelligence Techniques for Controlling an Interaction Dispute

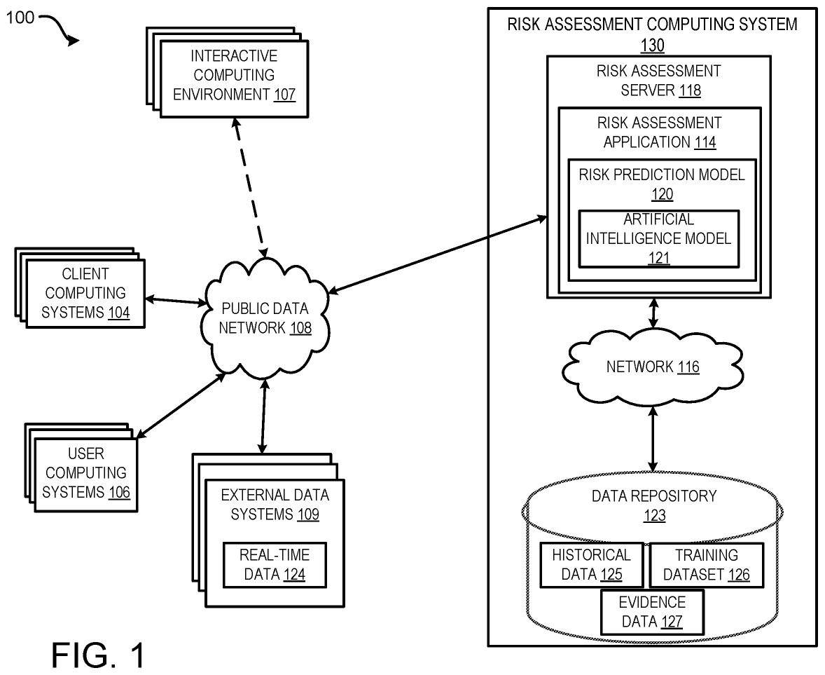

Referring now to the drawings, FIG. 1 is a block diagram illustrating an example of a computing environment 100 in which artificial intelligence techniques can be used to control an interaction dispute according to certain aspects of the present disclosure. FIG. 1 illustrates examples of hardware components of a risk assessment computing system 130 according to some aspects. The risk assessment computing system 130 can be a specialized computing system that may be used for processing large amounts of data, such as for controlling access to an interactive computing environment 107, for facilitating control of an interaction dispute involving a target entity (e.g., a receiving entity) and a providing entity, for determining a likelihood that the interaction dispute submitted by the receiving entity is legitimate, etc., using a large number of computer processing cycles. The risk assessment computing system 130 can include a risk assessment server 118 for validating risk assessment data from various sources. In some examples, the risk assessment computing system 130 can include other suitable components, servers, subsystems, and the like.

The risk assessment server 118 can include one or more processing devices that can execute program code, such as a risk assessment application 114, a risk prediction model 120, an artificial intelligence model 121, and the like. The program code can be stored on a non-transitory computer-readable medium or other suitable medium. The risk assessment server 118 can perform risk assessment validation operations or access control operations for validating or otherwise authenticating, for example using other suitable modules, services, models, components, etc. of the risk assessment server 118, received data such as entity data, evidence data, and interaction data (e.g., historical data 125, etc.), and the like received from user computing systems 106, client computing systems 104, external data systems 109, one or more data repositories, or any suitable combination thereof. In some examples, the risk assessment application 114 can determine a likelihood of success for traversing the interaction dispute by utilizing real-time data 124, the historical data 125, any information determined therefrom, or by utilizing any other suitable data.

The real-time data 124 may be received by the external data systems 109, though the real-time data 124 may be received from other suitable sources. The historical data 125 can be determined or stored in one or more network-attached storage units on which various repositories, databases, or other structures are stored. An example of these data structures can include data repository 123. Additionally or alternatively, a training dataset 126, evidence data 127, or the like can be stored in the data repository 123. In some examples, the training dataset 126 can be used to train the artificial intelligence model 121, one or more machine-learning models, which may include a supervised machine-learning model, an unsupervised machine-learning model, a generative artificial intelligence model, and the like, included therein, etc. The evidence data 127 may be data associated with the interaction dispute that may be useful for a traversal of the interaction dispute. The artificial intelligence model 121 can be trained to generate one or more risk signals based on the real-time data 124, the historical data 125, or a combination thereof, and the artificial intelligence model 121, or any model included therein, can be trained to determine a risk indicator based at least in part on the one or more risk signals to control access to the interactive computing environment 107 using the risk indicator, to facilitate control of the interaction dispute requested by a receiving entity, or to otherwise provide digital enablement for the receiving entity, etc.

Network-attached storage units may store a variety of different types of data organized in a variety of different ways and from a variety of different sources. For example, the network-attached storage unit may include storage other than primary storage located within the risk assessment server 118 that is directly accessible by processors located therein. In some aspects, the network-attached storage unit may include secondary, tertiary, or auxiliary storage, such as large hard drives, servers, and virtual memory, among other types of suitable storage. Storage devices may include portable or non-portable storage devices, optical storage devices, and various other mediums capable of storing and containing data. A machine-readable storage medium or computer-readable storage medium may include a non-transitory medium in which data can be stored and that does not include carrier waves or transitory electronic signals. Examples of a non-transitory medium may include, for example, a magnetic disk or tape, optical storage media such as a compact disk or digital versatile disk, flash memory, memory devices, or other suitable media.

Furthermore, the risk assessment computing system 130 can communicate with various other computing systems. The other computing systems can include user computing systems 106, such as smartphones, personal computers, etc., client computing systems 104, and other suitable computing systems. For example, user computing systems 106 may transmit, such as in response to receiving input from the receiving entity, requests for accessing the interactive computing environment 107, requests for initiating interaction disputes, or the like to the client computing systems 104 or to the external data systems 109. The client computing systems 104 can send authentication queries, risk assessment queries, or the like to the risk assessment server 118, and the risk assessment server 118 can receive data about the interaction dispute, historical data, or the like for generating risk signals, for determining a risk indicator, for generating a rank-order list of evidence data, or any combination thereof. While FIG. 1 illustrates that the risk assessment computing system 130 and the client computing systems 104 are separate systems, the risk assessment computing system 130 and the client computing systems 104 can be one system. For example, the risk assessment computing system 130 can be a part of the client computing systems 104, or vice versa.

As illustrated in FIG. 1, the risk assessment computing system 130 may interact with the client computing systems 104, the user computing systems 106, or a combination thereof via one or more public data networks 108 to facilitate interactions between users of the user computing systems 106 and the interactive computing environment 107. For example, the risk assessment computing system 130 can facilitate the client computing systems 104 providing a user interface to the user computing system 106 for receiving various data, such as data that can be used or that was previously used to initiate an interaction, from the user. The risk assessment computing system 130 can transmit validated risk assessment data, for example a risk indicator, a rank-order list, scores, a responsive message, etc., to the client computing systems 104 for providing, challenging, or rejecting, etc. access of the target entity to the interactive computing environment 107, for facilitating a decision with respect to whether to traverse the interaction dispute, or the like. In some examples, the risk assessment computing system 130 can additionally communicate with third-party systems, such as external data systems 109, to receive risk assessment data, entity data, interaction data, evidence data, and the like, through the public data network 108. In some examples, the third-party systems can provide real-time, such as streamed, data about the receiving entity, historical data about the receiving entity, the evidence data, etc. to the risk assessment computing system 130.

Each client computing system 104 may include one or more devices such as individual servers or groups of servers operating in a distributed manner. A client computing system 104 can include any computing device or group of computing devices operated by a seller, lender, provider, or other suitable entity that can provide goods or services. The client computing system 104 can include one or more server devices. The one or more server devices can include or can otherwise access one or more non-transitory computer-readable media.

The client computing system 104 can further include one or more processing devices that can be capable of providing an interactive computing environment 107, such as a user interface, etc., that can perform various operations. The interactive computing environment 107 can include executable instructions stored in one or more non-transitory computer-readable media. The instructions providing the interactive computing environment can configure one or more processing devices to perform the various operations. In some examples, the executable instructions for the interactive computing environment can include instructions that provide one or more graphical interfaces. The graphical interfaces can be used by a user computing system 106 to access various functions of the interactive computing environment 107. For instance, the interactive computing environment 107 may transmit data to and receive data, such as via the graphical interface, from a user computing system 106 to shift between different states of the interactive computing environment 107, where the different states allow one or more electronic interactions between the user computing system 106 and the client computing system 104 to be performed.

In some examples, the client computing system 104 may include other computing resources associated therewith (e.g., not shown in FIG. 1), such as server computers hosting and managing virtual machine instances for providing cloud computing services, server computers hosting and managing online storage resources for users, server computers for providing database services, and others. The interaction between the user computing system 106, the client computing system 104, and the risk assessment computing system 130, or any suitable sub-combination thereof may be performed through graphical user interfaces, such as the user interface, presented by the risk assessment computing system 130, the client computing system 104, other suitable computing systems of the computing environment 100, or any suitable combination thereof. The graphical user interfaces can be presented to the user computing system 106. Application programming interface (API) calls, web service calls, or other suitable techniques can be used to facilitate interaction between any suitable combination or sub-combination of the client computing system 104, the user computing system 106, and the risk assessment computing system 130.

A user computing system 106 can include any computing device or other communication device that can be operated by a user or entity, such as the receiving entity, which may include a consumer or a customer. The user computing system 106 can include one or more computing devices such as laptops, smartphones, and other personal computing devices. A user computing system 106 can include executable instructions stored in one or more non-transitory computer-readable media. The user computing system 106 can additionally include one or more processing devices configured to execute program code to perform various operations. In various examples, the user computing system 106 can allow a user to access certain online services or other suitable products, services, or computing resources from a client computing system 104, to engage in mobile commerce with the client computing system 104, to obtain controlled access to electronic content, such as the interactive computing environment 107, hosted by the client computing system 104, etc.

In some examples, the target entity can use the user computing system 106 to engage in an electronic interaction with the client computing system 104 via the interactive computing environment 107. In additional examples, the target entity can use the user computing system 106 to submit, for example via the interactive computing environment 107 or via other suitable interactive computing environments, an interaction dispute. The risk assessment computing system 130 can receive a request, for example from the client computing system 104, to perform a risk assessment regarding the interaction dispute and can use data, such as the real-time data 124, the historical data 125, the training dataset 126, the evidence data 127, or any other suitable data or signals determined therefrom, to generate a responsive message to facilitate a decision regarding whether to traverse the interaction dispute, and the like. An electronic interaction between the user computing system 106 and the client computing system 104 can include, for example, the user computing system 106 being used to request products from the client computing system 104, and so on, and an interaction dispute may include an indication from the user computing system 106 that the target entity is requesting resources from the client computing system 104 due to an allegedly failed interaction. An electronic interaction between the user computing system 106 and the client computing system 104 can also include, for example, one or more queries for a set of sensitive or otherwise controlled data, accessing online financial services provided via the interactive computing environment 107, submitting an online credit card application or other digital application to the client computing system 104 via the interactive computing environment 107, operating an electronic tool, such as a content-modification feature, an application-processing feature, within the interactive computing environment 107, etc. In some examples, an interactive computing environment 107 implemented through the client computing system 104 can be used to provide access to various online functions. As a simplified example, a user interface or other interactive computing environment 107 provided by the client computing system 104 can include electronic functions for requesting computing resources, online storage resources, network resources, database resources, real-world items or goods, or other types of resources.

A user computing system 106 can be used to request access to the interactive computing environment 107 provided by the client computing system 104, to submit an interaction dispute via the interactive computing environment 107 or other suitable computing environments, or the like. The client computing system 104 can submit a request, such as in response to the interaction dispute made by the user computing system 106, for risk assessment to the risk assessment computing system 130 and can selectively grant or deny access to various electronic functions, can decide to traverse or to not traverse the interaction dispute, based on risk assessment performed by the risk assessment computing system 130. Based on the interaction dispute and data associated therewith, the risk assessment computing system 130 can determine one or more risk signals, a risk indicator, a rank-order list, or the like for data associated with the interaction dispute submitted by the receiving entity, which may submit or may have submitted the interaction dispute via the user computing system 106. Based on a output generated using the artificial intelligence model 121, the risk assessment computing system 130, the client computing system 104, or a combination thereof can determine whether to grant the access request of the user computing system 106 to certain features of the interactive computing environment 107 or whether to traverse the interaction dispute. The risk assessment computing system 130, the client computing system 104, or a combination thereof can use the output from the artificial intelligence model 121 for other suitable purposes such as identifying a manipulated identity, controlling a real-world interaction, and the like.

In a simplified example, the system illustrated in FIG. 1 can configure the risk assessment server 118 to be used for controlling access to the interactive computing environment 107, for facilitating a decision regarding whether to traverse the interaction dispute, or the like. The risk assessment server 118 can receive data about a receiving entity that submitted the interaction dispute, for example, based on the information, such as information collected by the client computing system 104 via a user interface provided to the user computing system 106, provided by the client computing system 104 or received via other suitable computing systems. The risk assessment server 118 can additionally or alternatively receive historical interaction data, historical evidence data, historical interaction dispute data, real-time data, and the like relating to the interaction dispute. The risk assessment server 118 can use the artificial intelligence model 121 to determine one or more risk signals, a risk indicator, a rank-order list, a response, or the like for traversing the interaction dispute based at least in part on the received data. The risk assessment server 118 can transmit the risk indicator, or any responsive message or inference derived therefrom, to the client computing system 104 for use in controlling access to the interactive computing environment 107, for use in traversing the interaction dispute, or whether to do so, or the like.

The risk indicator, or the responsive message, can be utilized, for example by the risk assessment computing system 130, the client computing system 104, or the like, to determine whether the risk associated with the interaction dispute exceeds a threshold, thereby determining whether to traverse the interaction dispute. For example, if the risk assessment computing system 130 determines that the risk indicator indicates that risk of the interaction dispute is lower than a threshold value, then the client computing system 104 associated with the service provider can generate or otherwise provide access permission to the user computing system 106 that requested the reverse interaction. The access permission can include, for example, cryptographic keys used to generate valid access credentials or decryption keys used to decrypt access credentials. The client computing system 104 can also allocate resources to the receiving entity and provide a dedicated web address for the allocated resources to the user computing system 106, for example, by adding the user computing system 106 in the access permission. With the obtained access credentials or the dedicated web address, the user computing system 106 can establish a secure network connection to the interactive computing environment 107 hosted by the client computing system 104 and access the resources via invoking API calls, web service calls, HTTP requests, other suitable mechanisms or techniques, etc. Additionally or alternatively, the obtained access credentials or the dedicated web address can be used by the user computing system 106 to allow the interaction dispute to stand, for example without traversing the interaction dispute. In other examples, if the risk assessment computing system 130 determines that the risk indicator indicates that risk of the interaction dispute exceeds a threshold value, then the client computing system 104 associated with the service provider can use the responsive message provided by the risk assessment computing system 130 to traverse the interaction dispute.

In some examples, the risk assessment computing system 130 may determine whether to grant, challenge, or deny the request made by the user computing system 106 for accessing the interactive computing environment 107 or for whether to traverse the interaction dispute. For example, based on the risk indicator, the responsive message, or inferences derived thereof, the risk assessment computing system 130 can determine that the interaction dispute submitted by the receiving entity is legitimate and may take no action or otherwise allow the interaction dispute to proceed. In other examples, the risk assessment computing system 130 can traverse the interaction dispute if the risk assessment computing system 130 determines that the interaction dispute submitted by the receiving entity may not be legitimate or may otherwise be associated with malicious intent.

Each communication within the computing environment 100 may occur over one or more data networks, such as a public data network 108, a network 116 such as a private data network, or some combination thereof. A data network may include one or more of a variety of different types of networks, including a wireless network, a wired network, or a combination of a wired and wireless network. Examples of suitable networks include the Internet, a personal area network, a local area network (“LAN”), a wide area network (“WAN”), or a wireless local area network (“WLAN”). A wireless network may include a wireless interface or a combination of wireless interfaces. A wired network may include a wired interface. The wired or wireless networks may be implemented using routers, access points, bridges, gateways, or the like, to connect devices in the data network.

The number of devices depicted in FIG. 1 is provided for illustrative purposes. Different numbers of devices may be used. For example, while certain devices or systems are shown as single devices in FIG. 1, multiple devices may instead be used to implement these devices or systems. Similarly, devices or systems that are shown as separate, such as the risk assessment server 118 and the data repository 123, etc., may be instead implemented in a single device or system. Similarly and as discussed above, the risk assessment computing system 130 may be a part of the client computing system 104.

### Artificial Intelligence Techniques for Controlling an Interaction Dispute

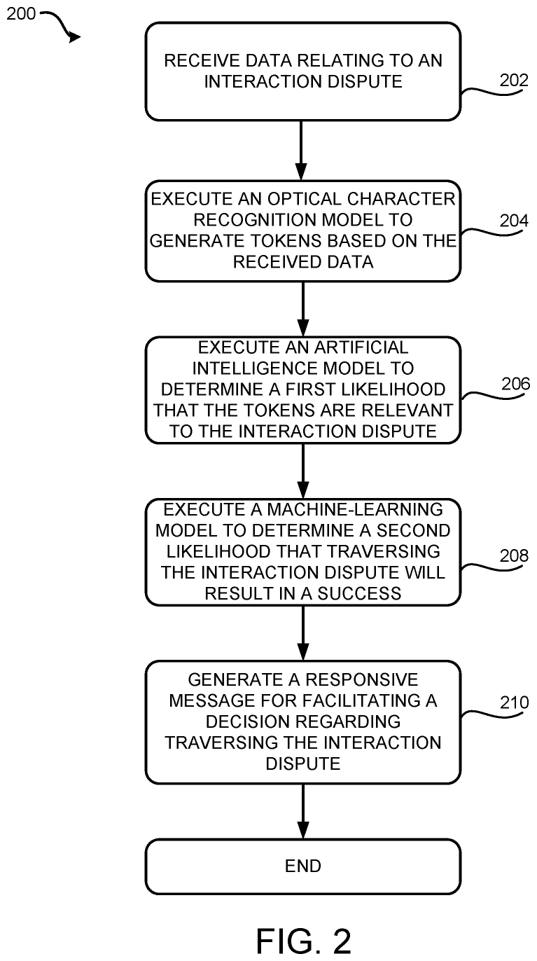

FIG. 2 is a flow chart illustrating an example of a process 200 for using artificial intelligence techniques to control an interaction dispute according to certain aspects of the present disclosure. One or more computing devices, such as the risk assessment computing system 130, may implement operations illustrated in FIG. 2 by executing suitable program code such as the artificial intelligence model 121, the risk prediction model 120, or the like. For illustrative purposes, the process 200 is described with reference to certain examples depicted in the figures. Other implementations, however, are possible.

At block 202, the process 200 involves receiving data relating to an interaction dispute. A target entity, or a receiving entity, may use a user computing system 106 to generate and submit the interaction dispute. In some examples, the interaction dispute may include an indication that a previously executed interaction between the target entity and a providing entity was unsuccessful in the opinion of the target entity. An unsuccessful interaction may involve an interaction in which goods, services, content, or the like were not successfully provided to the target entity, in which the goods, services, content, or the like provided to the target entity were not satisfactory, etc. The interaction dispute may be illegitimate or otherwise associated with malicious intent. For example, the target entity may be satisfied with the interaction, or the interaction may be successful. But, the target entity may still submit the interaction dispute to recover resources provided to initiate the interaction without intending to return the goods, the services, the content, or the like.

The data relating to the interaction dispute can include entity data, interaction data, evidence data, and any other suitable data associated with the interaction dispute. The entity data can include identity data provided by the target entity, and the identity data can include a name, a physical address, a digital address, a phone number, or any other suitable identity data associated with the target entity. The interaction data can include data about the interaction associated with the interaction dispute. For example, the interaction data can include a type of interaction, can include indications of goods, services, or content provided via the interaction, can include a time or date of the interaction, or any other suitable interaction data associated with the interaction. The evidence data can include data that can be used to characterize the interaction. For example, the evidence data can include delivery confirmation data, payment confirmation data, contracts or other agreements between the target entity and the providing entity, images of the goods, services, or content associated with the interaction, or any other suitable evidence data associated with the interaction. The data can be received by the risk assessment computing system 130 as PDF data files, as image files (e.g., PNG files, JPEG files, etc.), or other non-text-based data. In some examples, a subset of the received data may be or include text-based data.

At block 204, the process 200 involves executing an optical character recognition (OCR) model to generate tokens based on the received data. The risk assessment computing system 130 may include an OCR model, may be communicatively coupled with a separate computing device that includes an OCR model, or may otherwise be configured to execute the OCR model. The OCR model may receive at least a portion of the received data having non-text-based data to generate the tokens. For example, the OCR model can receive one or more PDF files, one or more image files, or the like from the received data. The OCR model can generate one or more tokens that represent the one or more PDF files, the one or more images files, or any data included therein. For example, a PDF file that represents a delivery confirmation evidence can be input into the OCR model, and the OCR model can generate one or more text-based tokens that can represent the delivery confirmation evidence. The risk assessment computing system 130 can execute the OCR model on each non-text-based file included in the evidence data to convert each non-text-based file into text-based tokens that can be input into the artificial intelligence model 121.

At block 206, the process 200 involves executing the artificial intelligence model 121 to determine a first likelihood that represents a similarity between at least a subset of the set of tokens and the interaction dispute. The artificial intelligence model 121 can include a natural language processing (NLP) model, a generative artificial intelligence model, a machine-learning model, other suitable models, or any combination thereof. The NLP model can include a word2vec model, a BERT-based model, any other suitable NLP model, or any combination thereof. The generative artificial intelligence model can include a large language model (LLM) having an adapter layer or any other suitable type of generative artificial intelligence model. The machine-learning model can include a computer vision model, a probabilistic model, other suitable type of machine-learning model, or any combination thereof.

The artificial intelligence model 121 can receive the tokens and can provide the tokens to the NLP model, the LLM, the machine-learning model, or a combination thereof. In some examples, the tokens can be input into the NLP model, which can generate an output that can be input into the LLM, and so on. In other examples, the tokens can be input into the NLP model, the LLM, and the machine-learning model, or any subset thereof, in parallel. In a particular example, the tokens can be provided to the NLP model to identify patterns represented by the tokens, to identify personally identifiable information or protected personal information, and to generate any additional outputs. The NLP model can be used to reduce the tokens to a set of tokens that represent evidence that can be used to respond to, or to traverse, the interaction dispute. Additionally or alternatively, the NLP model can be used to filter out personally identifiable information, protected personal information, or other controlled information that may not be disclosed without prior, express authorization. An output of the NLP model can include text-based tokens or other text-based data representing evidence relevant to the interaction dispute and that may not include personal data.

The output of the NLP model can be provided to the LLM, which may include an adapter layer. The adapter layer may configure the LLM to evaluate the output from the NLP to determine first types or classifications of evidence represented by the tokens included in the output from the NLP. Additionally or alternatively, the adapter layer can be used to determine, based at least in part on the interaction dispute or any data associated therewith, a second type or classification of evidence that may be useful for responding to the interaction dispute. Being useful for responding to the interaction dispute may mean that the corresponding type or classification of evidence has previously been successful in responding to a historical interaction dispute, may mean that the corresponding type or classification of evidence may be successful in responding to future historical interaction disputes, or the like. The LLM, or the adapter layer included therein, may compare the first types or classifications of evidence with the second type or classification of evidence that may be useful to determine a similarity. In other examples, the LLM can output the types or classifications generated by the adapter layer for input into the machine-learning model.

The machine-learning model may be or include a computer vision model, a probabilistic model, a deep learning model, or any other suitable type of machine-learning model. The machine-learning model may receive the tokens, may receive an output from the LLM, may receive other input from the risk assessment computing system 130 or any component included therein, or any combination thereof. For example, the machine-learning model can receive the first types or classifications and the second type or classification from the LLM, and the machine-learning model can generate a first likelihood. In some examples, the first likelihood may be or include a score, such as a cosine similarity, a Euclidean distance, or the like, that indicates a similarity between the first types or classifications, as-a-whole, and the second type or classification. In other examples, the first likelihood may be or include a set of scores, such as a set of cosine similarity scores, a set of Euclidean distances, combinations thereof, or the like, that may each indicate a similarity between a different type or classification of the first types or classifications and the second type or classification.

The set of scores can be used to generate a rank-order list that may arrange each token of the subset of the set of tokens by a similarity between a corresponding first type or classification and the second type or classification. In some examples, the rank-order list may be, may be included in, or may include the first likelihood. The rank-order list may arrange the subset of the set of tokens such that a particular token associated with evidence data that is more likely to be useful in responding to or traversing the interaction dispute than a different token may be presented more prominently (e.g., higher on the rank-order list, larger, bolder, etc.) than the different token. The machine-learning model may provide, as an output, the first likelihood, the rank-order list, or a combination thereof, for example if the first likelihood is different than the rank-order list.

At block 208, the process 200 involves executing a machine-learning model to determine a second likelihood that traversing the interaction dispute will be successful. In some examples, the machine-learning model executed at the block 208 may be different than the machine-learning model included in the artificial intelligence model 121. In other examples, the machine-learning model executed at the block 208 may be the same machine-learning model included in the artificial intelligence model 121. The machine-learning model may be trained to map received inputs to outputs that may include the second likelihood. The received inputs may include interaction dispute data, such as a type of interaction being disputed, may include the evidence data, such as the text-based data provided by the OCR model, may include the entity data, such as the identity data associated with the target entity, may include the first likelihood or the rank-order list, and the like. The machine-learning model may be trained on historical data, such as historical interaction dispute data, historical entity data, historical interaction data, and the like. The machine-learning model can map the received inputs, for example based on layer weights tuned via a training process, to the output that includes the second likelihood. In some examples, the second likelihood can be or include a score that indicates a likelihood of succeeding in traversing the interaction dispute using the available evidence data. In a particular example, the second likelihood may be or include a percentage that represents an expected chance of success traversing the interaction dispute using the available evidence data.

At block 210, the process 200 involves generating a responsive message that can be used to control the interaction dispute. In some examples, the risk assessment server 118 (or any other suitable module, model, or computing device) can generate, transmit, or a combination thereof the responsive message to a computing device (e.g., the client computing system 104) or any other suitable computing device that can control the interaction dispute or a decision regarding whether to traverse the interaction dispute. The responsive message can vary based on the first likelihood determined at the block 206, based on the second likelihood determined at the block 208, or a combination thereof. For example, the responsive message may include the second likelihood and may indicate a high chance of success in traversing the interaction dispute using the available evidence. In such examples, the responsive message may include a recommendation to traverse the interaction dispute or may include a recommendation for denying access by the receiving entity to the interactive computing environment 107 for allowing the interaction dispute to proceed. In other examples, the responsive message may include the second likelihood and may indicate a low chance of success in traversing the interaction dispute using the available evidence. In such examples, the responsive message may include a recommendation to take no action, to evaluate a value associated with traversing the interaction dispute prior to deciding whether to traverse the interaction dispute, and the like.

In some examples, the responsive message may include a response to the interaction dispute. The response may be or include a letter to a third-party entity that may decide whether the interaction dispute is legitimate, and the letter may include the available evidence arranged in such a manner as to optimize a success of the response. The response may additionally or alternatively include a first description of a corresponding providing entity, a second description of goods, services, or content associated with the interaction dispute, a third description of the interaction associated with the interaction dispute, and the like. The first description, the second description, the third description, or a combination thereof may be generated by providing one or more inputs to a LLM such as the LLM included in the artificial intelligence model 121. For example, information about the providing entity may be provided to the LLM, and the LLM may generate the first description. Additionally or alternatively, information about the goods, the services, or the content may be provided to the LLM, and the LLM may generate the second description. Additionally or alternatively, the interaction data, or any other data about the interaction dispute, can be provided to the LLM, and the LLM may generate the third description. The risk assessment computing system 130 may additionally provide the evidence data to the LLM as input and may cause the LLM to augment the first description, the second description, the third description, or a combination thereof with the optimized presentation of the evidence data to generate the response, which may be optimized to result in a successful traversal of the interaction dispute. The risk assessment computing system 130 can include the optimized response in the responsive message regardless of a recommendation regarding whether to traverse the interaction dispute.

### Techniques for Controlling an Interaction Using Artificial Intelligence

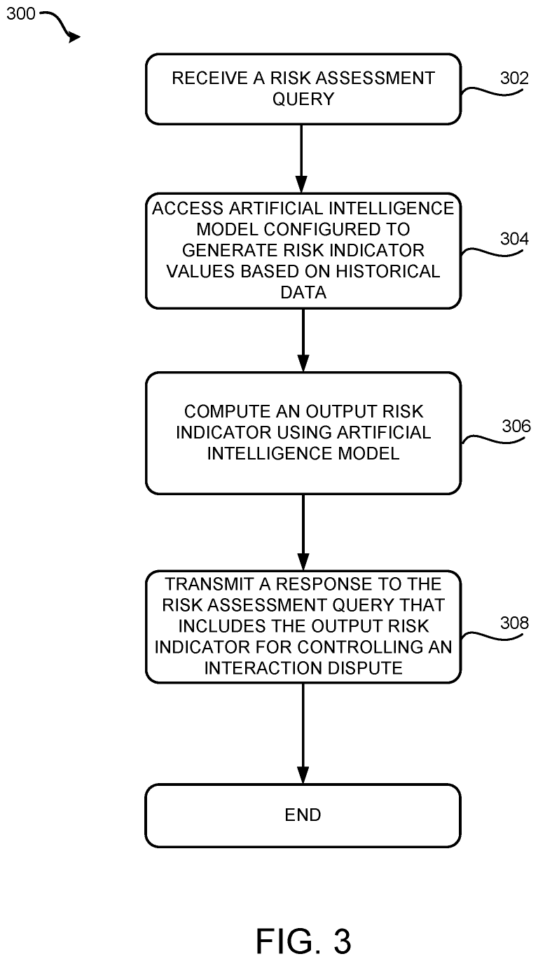

FIG. 3 is a flow chart illustrating an example of a process 300 for determining a risk assessment indicator using artificial intelligence techniques according to certain aspects of the present disclosure. One or more computing devices, such as the risk assessment computing system 130, may implement operations illustrated in FIG. 3 by executing suitable program code such as the artificial intelligence model 121, the risk prediction model 120, and the like. For illustrative purposes, the process 300 is described with reference to certain examples depicted in the figures. Other implementations, however, are possible.

At block 302, the process 300 involves receiving a risk assessment query for an interaction dispute from a remote computing device such as a computing device associated with a providing entity. The interaction dispute may be submitted by a user computing device based on input provided by a target entity such as a receiving entity. The receiving entity may have previously initiated an interaction and may cause the interaction dispute to be submitted. The risk assessment query can also be received by the risk assessment server 118 from a remote computing device associated with an entity authorized to request risk assessment of the interaction dispute, etc. The risk assessment query may involve a request for determination for whether the interaction dispute, or the target entity associated therewith, is associated with potentially malicious intent, such as first-party fraud or other types of fraud, is otherwise illegitimate, or the like.

At block 304, the process 300 involves accessing a risk prediction model 120 trained or otherwise configured to generate a risk assessment indicator using the artificial intelligence model 121. In some examples, the risk prediction model 120 may additionally or alternatively be or include one or more proprietary models (e.g., artificial intelligence models, machine-learning models, etc.), one or more heuristics models, and/or one or more simulation models. The artificial intelligence model 121 can include an NLP model, a LLM model, which may include an adapter layer, a machine-learning model, other suitable models, or any suitable combination thereof, and the artificial intelligence model 121 may be trained on, or receive as input, data such as entity data, identity data, historical interaction data, historical interaction dispute data, historical evidence data, and the like. Additionally or alternatively, a first likelihood can be generated by the artificial intelligence model 121 as described at least with respect to the block 206 of the process 200. Examples of entity data can include identity data, such as name, address, etc., and examples of interaction data can include a time of interaction, an amount of resources associated with the interaction, a success status of a corresponding interaction or reversal thereof, etc. The risk assessment indicator can include the first likelihood, can include a rank-order list, and the like, and the risk assessment indicator can indicate a level of risk associated with the interaction dispute, or the target entity associated therewith. In some examples, the risk assessment indicator can include indicators such as a credit score or fraud score of the target entity. In some examples, a linked graph can be used to determine the risk indicator. For example, the risk prediction model 120 can traverse the linked graph, can execute one or more clustering or other suitable machine-learning models on the linked graph, and the like to determine the risk assessment indicator.

At block 306, the process 300 involves computing a risk assessment indicator for the interaction dispute using the artificial intelligence model 121. In some examples, the risk prediction model 120 can be used to determine the risk assessment indicator, though in other examples, other components or models (e.g., the artificial intelligence model 121, a separate machine-learning model, etc.) of the risk assessment computing system 130 can be used to determine the risk assessment indicator. The artificial intelligence model 121 can generate the first likelihood, the rank-order list, or a combination thereof that can be used as input to the risk prediction model 120. The risk prediction model 120 can generate output, which may include the second likelihood as described with respect to the block 208 of the process 200, by using the separate machine-learning model to generate the second likelihood, which may represent a likelihood of success in traversing the interaction dispute using available evidence data. The output of the risk prediction model 120 can be or include the risk assessment indicator for the interaction dispute or for the target entity associated with the interaction dispute.

At block 308, the process 300 involves transmitting a responsive message based on the risk assessment indicator, which may be determined at the block 306. In some examples, the risk assessment server 118, or any other suitable module, model, or computing device, can transmit the responsive message to a computing device, such as the client computing system 104, or any other suitable computing device that can control the interaction dispute or any decision associated therewith. The responsive message can vary based on the risk assessment indicator or based on the first likelihood, the second likelihood, or a combination thereof. For example, the responsive message may indicate that the interaction dispute is legitimate (e.g., not associated with potentially malicious intent) and may recommend not responding to the interaction dispute or may recommend allowing the interaction dispute to proceed based on the responsive message. In other examples, the responsive message may indicate that the interaction dispute submitted by the target entity is likely associated with malicious intent or may otherwise not be associated with legitimate activity and may recommend traversing the interaction dispute. Additionally or alternatively, the responsive message may include an indication, such as the second likelihood, that can indicate an expected chance of success in traversing the interaction using the available evidence data.

In some examples, the responsive message may additionally or alternatively include a response to the interaction dispute regardless of a recommendation for whether to traverse or otherwise respond to the interaction dispute. The risk prediction model 120, or any other suitable component or service included in the risk assessment computing system 130, can cause the response to be generated by providing various input to a generative artificial intelligence model such as the LLM included in the artificial intelligence model 121. For example, the risk prediction model 120 can provide (e.g., simultaneously, in series, etc.) the evidence data, information about the providing entity, information about goods, services, or content associated with the interaction dispute, and the like into the generative artificial intelligence model, which can generate the response. The response may be or include a formal letter optimized to maximize an expected chance of success of traversing the interaction dispute using the formal letter. Other suitable examples of the response are possible without departing from the scope of the present disclosure.

### Example of an Architecture for Artificial Intelligence Model

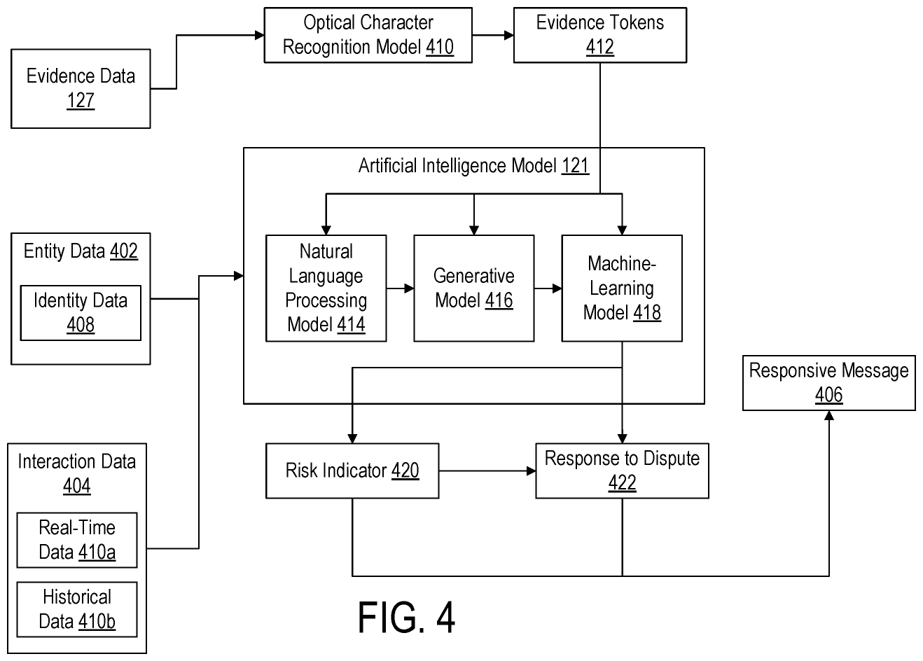

FIG. 4 is a block diagram of an example of an architecture 400 of an artificial intelligence model that can be used to control an interaction dispute according to certain aspects of the present disclosure. As illustrated in FIG. 4, the artificial intelligence model 121 can include a natural language processing (NLP) model 414, a generative artificial intelligence model (LLM) 416, and a machine-learning model 418, though the artificial intelligence model 121 may include any suitable, additional or alternative models, services, or the like to provide functionality for the artificial intelligence model 121. The NLP model 414 may be communicatively coupled with the LLM 416, the machine-learning model 418, or a combination thereof, or any permutation thereof. Additionally or alternatively, the NLP model 414, the LLM 416, and the machine-learning model 418 may be configured to operate in series, in parallel, or in a combination thereof.

The artificial intelligence model 121 may be communicatively coupled with, or may otherwise be configured to access, an optical character recognition (OCR) model 410. The OCR model 410 may receive non-text-based input and may generate tokens or other types of text-based input based at least in part on the non-text-based input. In a particular example relating to an interaction dispute, the OCR model 410 can receive the evidence data 127, which may include PDF files, image files, and the like, and may generate evidence tokens 412 based on the evidence data 127.

The artificial intelligence model 121 can receive various data as input and can generate an output based at least in part on the input data. For example, and as illustrated in FIG. 4, the artificial intelligence model 121 can receive entity data 402, interaction data 404, and the evidence tokens 412, though other or alternative input is possible to provide to the artificial intelligence model 121. The entity data 402 may include identity data 408 relating to a target entity such as the receiving entity associated with the interaction dispute. The identity data 408 can include a name of the target entity, a physical address of the target entity, a digital address of the target entity, family members of the target entity, a Social Security number of the target entity, and any other suitable personally identifiable information for the target entity. The identity data 408 may be stored in a data repository, such as the data repository 123, and the risk assessment computing system 130 can access the data repository to receive the identity data 408. In other examples, the identity data 408 may be streamed, such as in approximately real-time, to the risk assessment computing system 130 based on streamed interactions.

The interaction data 404 may include real-time interaction data 410a and historical interaction data 410b, which may additionally include historical interaction dispute data, though other suitable data or types of data are possible. Interaction data may include a time or day of a particular interaction, a type or amount of resources associated with the particular interaction, separate entities with which the target entity interacts with for the particular interaction, historical interaction disputes, outcomes of the historical interaction disputes, and the like. The real-time interaction data 410a may be generated in approximately real-time and may be streamed or otherwise substantially contemporaneously transmitted to the risk assessment computing system 130. The historical interaction data 410b may be stored in a data repository such as the data repository 123. The risk assessment computing system 130 can access the data repository 123 to receive the historical interaction data 410b. The interaction data 404 may include labeled data, unlabeled data, or a combination thereof. The evidence tokens 412 may include one or more tokens, or other suitable types of text-based data, generated by the OCR model 410 based on the evidence data 127 associated with the interaction dispute.

The entity data 402, the interaction data 404, the evidence tokens 412, or any combination thereof can be transmitted to or otherwise suitably received by the artificial intelligence model 121. In a particular example, the entity data 402, the interaction data 404, and the evidence tokens 412 can be streamed to the artificial intelligence model 121. The artificial intelligence model 121 can receive the entity data 402, the interaction data 404, the evidence tokens 412, or a combination thereof, and can direct each of the types of input data to each of the models, or a subset thereof, included in the artificial intelligence model 121. In some examples, the artificial intelligence model 121 can receive the entity data 402, the interaction data 404, the evidence tokens 412, or a combination thereof, and can input the received data into the NLP model 414 to initiate a sequence of operations in which the models included in the artificial intelligence model 121 may be executed in series, which is described below, though other suitable examples (e.g., parallel processing) are possible for executing the models of the artificial intelligence model 121.

The NLP model 414, which can be or include a BERT-based model, a word2vec model, etc., can receive the evidence tokens 412 and any other suitable input data and can generate a first output that may include a filtered set of tokens. In some examples, the filtered set of tokens may include tokens representing evidence data that may be related to the interaction dispute and that may exclude personal data. For example, the NLP model 414 can identify personally identifiable information, protected personal information, or the like in the evidence tokens 412 and can remove the personal data to generate the filtered set of tokens. The NLP model 414 can transmit the filtered set of tokens to the LLM 416, or the NLP model 414 can output the filtered set of tokens for the risk assessment computing system 130 to provide the filtered set of tokens to the LLM 416.

The LLM 416 may receive the filtered set of tokens and may generate a subset of the tokens, for example by applying classifications to each token included in the evidence tokens 412. In some examples, the LLM 416 can include an adapter layer that can configure the LLM 416 to generate a first type or classification of a token based on the type or classification of evidence that the token represents. Additionally or alternatively, the adapter layer of the LLM 416 can configure the LLM 416 to generate a second type or classification of the interaction dispute or any evidence associated therewith that may be useful for traversing the interaction dispute. Additionally or alternatively, the LLM 416 may be located (e.g., digitally) behind a firewall or a virtual private cloud (VPC) or may otherwise include one or more security features that prevent unauthorized disclosure of sensitive information that may be provided to the LLM 416. The LLM 416 can provide the subset of the tokens to the machine-learning model 418, or the LLM 416 can output the subset of the tokens for the risk assessment computing system to provide the subset of the tokens to the machine-learning model 418.

The machine-learning model 418 may be or include a computer vision model, a probabilistic model, a deep learning model, or any other suitable type of machine-learning model. The machine-learning model 418 can receive the subset of the tokens and can receive the entity data 402, the interaction data 404, or a combination thereof, and the machine-learning model 418 can generate an output that can include a first likelihood that may characterize a similarity between the subset of tokens and the interaction dispute. The output may include a single score representing the similarity, may include a set of scores representing a similarity between each token and the interaction dispute, may include a rank-order list based on the set of scores, and the like. The machine-learning model 418 may be trained, for example on historical entity data, historical interaction data, historical interaction dispute data, and the like, to generate the output based on the received input. The machine-learning model 418 can provide the first likelihood, the rank-order list, or a combination thereof, to the risk assessment computing system 130, or any suitable component included therein, for use in generating a responsive message 406.

The first likelihood may be a risk indicator 420 or may be included in the risk indicator 420. For example, the risk assessment computing system 130, or any suitable computer model or service (e.g., the risk prediction model 120) included therein, can execute a separate machine-learning model, or the machine-learning model 418, to generate a second likelihood that can be or that can be included in the risk indicator 420. The second likelihood can be or include an expected likelihood or chance of achieving success traversing the interaction dispute using the evidence data 127 or an optimized presentation thereof. For example, the second likelihood can be or include a percentage. Additionally or alternatively, the risk assessment computing system 130, or any suitable computer model or service (e.g., the risk prediction model 120) included therein, can provide various inputs to the LLM 416, or any other suitable generative artificial intelligence model, to generate a response 422 that can be used for traversing the interaction dispute. For example, the risk assessment computing system 130 can provide information about the providing entity, information about goods, services, or content associated with the interaction dispute, information about the interaction dispute, the evidence data 127, the rank-order list, or any other suitable input to the LLM 416, and the LLM 416 can generate an optimized version of the response 422 that can be used to traverse or otherwise respond to the interaction dispute.

The artificial intelligence model 121, or any other suitable component of the risk assessment computing system 130, can use the risk indicator 420 and the response 422 to generate the responsive message 406, which may be used to control access of the target entity to an interactive computing environment 107, to control a real-world interaction, such as the interaction dispute, to control a digital interaction involving the target entity, or any combination thereof. In a particular example, the artificial intelligence model 121, or any other suitable component of the risk assessment computing system 130, can transmit the responsive message 406 to the providing entity, or to a client computing system 104 associated with the providing entity, to facilitate a decision by the providing entity regarding whether to traverse the interaction dispute. In other examples, the artificial intelligence model 121, or any other suitable component of the risk assessment computing system 130, can transmit the responsive message 406 to the providing entity such that transmitting the responsive message 406 results in an automatic decision made regarding whether to traverse the interaction dispute.

### Example of Computing System

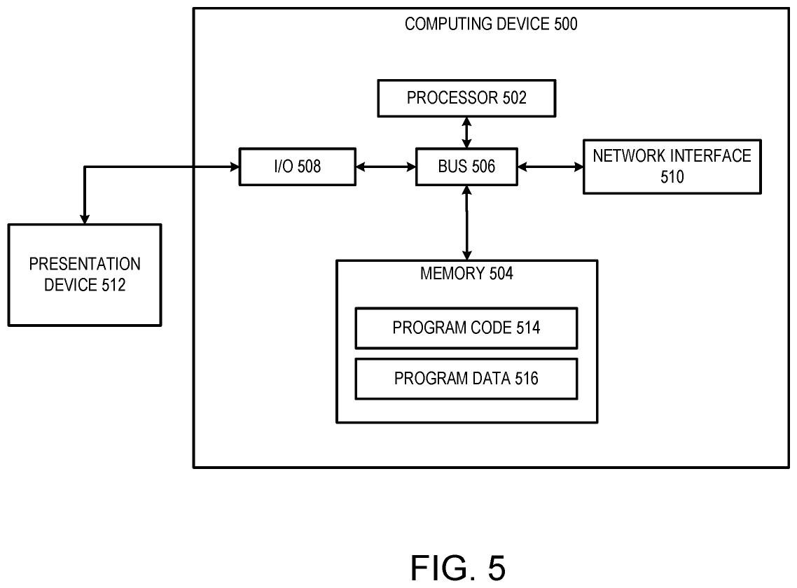

Any suitable computing system or group of computing systems can be used to perform the operations for the artificial intelligence techniques described herein. For example, FIG. 5 is a block diagram illustrating an example of a computing device 500, which can be used to implement the risk assessment server 118, the artificial intelligence model 121, or other suitable components of the computing environment 100. The computing device 500 can include various devices for communicating with other devices in the computing environment 100, for example as described with respect to FIG. 1. The computing device 500 can include various devices for performing one or more data consolidation or validation operations, artificial intelligence operations, or other suitable operations, described above with respect to FIGS. 1-4.

The computing device 500 can include a processor 502 that is communicatively coupled to a memory 504. The processor 502 can execute computer-executable program code stored in the memory 504, can access information stored in the memory 504, or both. Program code may include machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing or receiving information, data, arguments, parameters, or memory contents. Information, arguments, parameters, data, etc., may be passed, forwarded, or transmitted via any suitable means including memory sharing, message passing, token passing, network transmission, among others.

Examples of a processor 502 can include a microprocessor, an application-specific integrated circuit (ASIC), a field-programmable gate array (FPGA), or any other suitable processing device. The processor 502 can include any suitable number of processing devices, including one. The processor 502 can include or communicate with a memory 504. The memory 504 can store program code that, when executed by the processor 502, causes the processor 502 to perform the operations described herein.

The memory 504 can include any suitable non-transitory computer-readable medium. The computer-readable medium can include any electronic, optical, magnetic, or other storage device capable of providing a processor with computer-readable program code or other program code. Non-limiting examples of a computer-readable medium can include a magnetic disk, memory chip, optical storage, flash memory, storage class memory, ROM, RAM, an ASIC, magnetic storage, or any other medium from which a computer processor can read and execute program code. The program code may include processor-specific program code generated by a compiler or an interpreter from code written in any suitable computer-programming language. Examples of suitable programming language can include Hadoop, C, C++, C#, Visual Basic, Java, Python, Perl, JavaScript, ActionScript, etc.

The computing device 500 may also include a number of external or internal devices such as input or output devices. For example, the computing device 500 is illustrated with an input/output interface 508 that can receive input from input devices or provide output to output devices. A bus 506 can also be included in the computing device 500. The bus 506 can communicatively couple one or more components of the computing device 500.

The computing device 500 can execute program code 514 that can include the artificial intelligence model 121, or any other suitable computer model, computer module, computer service, or the like. The program code 514 for the artificial intelligence model 121 and the like may be resident in any suitable computer-readable medium and may be executed on any suitable processing device. For example, as depicted in FIG. 5, the program code 514 for the artificial intelligence model 121 can reside in, or may otherwise be included in, the memory 504 at the computing device 500 along with the program data 516 associated with the program code 514. Executing the artificial intelligence model 121 can configure the processor 502 to perform one or more of the operations, such as the artificial intelligence operations, described herein.

In some aspects, the computing device 500 can include one or more output devices. One example of an output device can be the network interface device 510 illustrated in FIG. 5. A network interface device 510 can include any device or group of devices suitable for establishing a wired or wireless data connection to one or more data networks described herein. Non-limiting examples of the network interface device 510 can include an Ethernet network adapter, a modem, etc.

Another example of an output device can include the presentation device 512 depicted in FIG. 5. A presentation device 512 can include any device or group of devices suitable for providing visual, auditory, or other suitable sensory output. Non-limiting examples of the presentation device 512 can include a touchscreen, a monitor, a speaker, a separate mobile computing device, etc. In some aspects, the presentation device 512 can include a remote client-computing device that can communicate with the computing device 500 using one or more data networks described herein. In other aspects, the presentation device 512 can be optional.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

What is claimed is:

1. A system comprising:
a processor; and
a non-transitory computer-readable medium comprising instructions that are executable by the processor to cause the processor to perform operations comprising:
receiving a set of tokens from an optical character recognition model, the set of tokens representing at least evidence data relating to an interaction dispute;
determining, using an artificial intelligence model that is configured to receive the set of tokens as input, a first likelihood that represents a similarity between at least a subset of the set of tokens and the interaction dispute;
determining, using a machine-learning model, a second likelihood that traversing the interaction dispute will result in success; and
providing a responsive message that controls the interaction dispute based on the first likelihood and the second likelihood, the responsive message including a response to the interaction dispute.

2. The system of claim 1, wherein the operations further comprise:
receiving data comprising entity data, interaction data, and evidence data, the data comprising non-text-based data files associated with the interaction dispute, wherein the entity data comprises identity data for a target entity that submitted the interaction dispute, wherein the interaction data comprises data relating to a previously executed interaction associated with the interaction dispute, and wherein the evidence data comprises data usable for characterizing the previously executed interaction; and
executing the optical character recognition model on the non-text-based data files to generate the set of tokens.

3. The system of claim 1, wherein the artificial intelligence model comprises a natural language processing model, a generative artificial intelligence model, and a trained machine-learning model, and wherein the generative artificial intelligence model comprises a large language model.

4. The system of claim 3, wherein the large language model comprises an adapter layer that configures the large language model to determine a first set of classifications for a subset of the set of tokens and a second classification relating to the interaction dispute.

5. The system of claim 1, wherein the operation of determining the first likelihood comprises:
executing a natural language processing model to generate a filtered set of tokens, wherein the filtered set of tokens includes tokens representing evidence data that are likely to relate to the interaction dispute, and wherein the filtered set of tokens does not include personal data;
executing a generative artificial intelligence model on the filtered set of tokens to generate the subset of the set of tokens, wherein the subset of the set of tokens are usable to respond to the interaction dispute, and wherein the subset of the set of tokens are generatable using an adapter layer of the generative artificial intelligence model; and
executing a trained machine-learning model to generate the first likelihood, wherein a rank-order list of the subset of the set of tokens is generatable by the trained machine-learning model, and wherein the rank-order list arranges each token included in the subset of the set of tokens by a likelihood of a successful traversal of the interaction dispute using a corresponding token.

6. The system of claim 5, wherein the operation of determining the second likelihood comprises executing the machine-learning model on historical interaction dispute data and the rank-order list to determine the second likelihood that using evidence data represented by the subset of the set of tokens to traverse the interaction dispute will result in success.

7. The system of claim 5, wherein the operation of providing the responsive message comprises generating the response using a generative artificial intelligence model to generate a response to include in the responsive message by using the subset of the set of tokens.

8. A method comprising:
receiving, by a computing system, a set of tokens from an optical character recognition model, the set of tokens representing at least evidence data relating to an interaction dispute;
determining, by the computing system and by using an artificial intelligence model that is configured to receive the set of tokens as input, a first likelihood that represents a similarity between at least a subset of the set of tokens and the interaction dispute;
determining, by the computing system and by using a machine-learning model, a second likelihood that traversing the interaction dispute will result in success; and
providing, by the computing system, a responsive message that controls the interaction dispute based on the first likelihood and the second likelihood, the responsive message including a response to the interaction dispute.

9. The method of claim 8, further comprising:
receiving data comprising entity data, interaction data, and evidence data, the data comprising non-text-based data files associated with the interaction dispute, wherein the entity data comprises identity data for a target entity that submitted the interaction dispute, wherein the interaction data comprises data relating to a previously executed interaction associated with the interaction dispute, and wherein the evidence data comprises data usable for characterizing the previously executed interaction; and
executing the optical character recognition model on the non-text-based data files to generate the set of tokens.

10. The method of claim 8, wherein the artificial intelligence model comprises a natural language processing model, a generative artificial intelligence model, and a trained machine-learning model, and wherein the generative artificial intelligence model comprises a large language model.

11. The method of claim 10, wherein the large language model comprises an adapter layer that configures the large language model to determine a first set of classifications for a subset of the set of tokens and a second classification relating to the interaction dispute.

12. The method of claim 8, wherein determining the first likelihood comprises:
executing a natural language processing model to generate a filtered set of tokens, wherein the filtered set of tokens includes tokens representing evidence data that are likely to relate to the interaction dispute, and wherein the filtered set of tokens does not include personal data;
executing a generative artificial intelligence model on the filtered set of tokens to generate the subset of the set of tokens, wherein the subset of the set of tokens are usable to respond to the interaction dispute, and wherein the subset of the set of tokens are generatable using an adapter layer of the generative artificial intelligence model; and
executing a trained machine-learning model to generate the first likelihood, wherein a rank-order list of the subset of the set of tokens is generatable by the trained machine-learning model, and wherein the rank-order list arranges each token included in the subset of the set of tokens by a likelihood of a successful traversal of the interaction dispute using a corresponding token.

13. The method of claim 12, wherein determining the second likelihood comprises executing the machine-learning model on historical interaction dispute data and the rank-order list to determine the second likelihood that using evidence data represented by the subset of the set of tokens to traverse the interaction dispute will result in success.

14. The method of claim 12, wherein providing the responsive message comprises generating the response using a generative artificial intelligence model to generate a response to include in the responsive message by using the subset of the set of tokens.

15. A non-transitory computer-readable medium comprising instructions that are executable by a processing device for causing the processing device to perform operations comprising:
receiving a set of tokens from an optical character recognition model, the set of tokens representing at least evidence data relating to an interaction dispute;
determining, using an artificial intelligence model that is configured to receive the set of tokens as input, a first likelihood that represents a similarity between at least a subset of the set of tokens and the interaction dispute;
determining, using a machine-learning model, a second likelihood that traversing the interaction dispute will result in success; and
providing a responsive message that controls the interaction dispute based on the first likelihood and the second likelihood, the responsive message including a response to the interaction dispute.

16. The non-transitory computer-readable medium of claim 15, wherein the operations further comprise:
receiving data comprising entity data, interaction data, and evidence data, the data comprising non-text-based data files associated with the interaction dispute, wherein the entity data comprises identity data for a target entity that submitted the interaction dispute, wherein the interaction data comprises data relating to a previously executed interaction associated with the interaction dispute, and wherein the evidence data comprises data usable for characterizing the previously executed interaction; and
executing the optical character recognition model on the non-text-based data files to generate the set of tokens.

17. The non-transitory computer-readable medium of claim 15, wherein the artificial intelligence model comprises a natural language processing model, a generative artificial intelligence model, and a trained machine-learning model, wherein the generative artificial intelligence model comprises a large language model, and wherein the large language model comprises an adapter layer that configures the large language model to determine a first set of classifications for a subset of the set of tokens and a second classification relating to the interaction dispute.

18. The non-transitory computer-readable medium of claim 15, wherein the operation of determining the first likelihood comprises:
executing a natural language processing model to generate a filtered set of tokens, wherein the filtered set of tokens includes tokens representing evidence data that are likely to relate to the interaction dispute, and wherein the filtered set of tokens does not include personal data;
executing a generative artificial intelligence model on the filtered set of tokens to generate the subset of the set of tokens, wherein the subset of the set of tokens are usable to respond to the interaction dispute, and wherein the subset of the set of tokens are generatable using an adapter layer of the generative artificial intelligence model; and
executing a trained machine-learning model to generate the first likelihood, wherein a rank-order list of the subset of the set of tokens is generatable by the trained machine-learning model, and wherein the rank-order list arranges each token included in the subset of the set of tokens by a likelihood of a successful traversal of the interaction dispute using a corresponding token.

19. The non-transitory computer-readable medium of claim 18, wherein the operation of determining the second likelihood comprises executing the machine-learning model on historical interaction dispute data and the rank-order list to determine the second likelihood that using evidence data represented by the subset of the set of tokens to traverse the interaction dispute will result in success.

20. The non-transitory computer-readable medium of claim 18, wherein the operation of providing the responsive message generating the response using a generative artificial intelligence model to generate a response to include in the responsive message by using the subset of the set of tokens.
